(19) United States
(12) Patent Application Publication
(10) Pub. No.: US 2018/0244978 A1
(43) Pub. Date: Aug. 30, 2018

(54) METHODS OF APPLYING HYBRID SOL-GEL SAM LAYERS TO EQUIPMENT AND PRODUCTS AND APPARATUS COMPRISING SUCH HYBRID LAYERS

(71) Applicant: ELECTROLAB, INC., BOERNE, TX (US)

(72) Inventors: SEAN ERIC DREES, BOERNE, TX (US); TODD MATHIAS, SPRING, TX (US); AJEETA PATIL, SAN ANTONIO, TX (US); CHRISTOPHER GALLAGHER, SPRING, TX (US)

(21) Appl. No.: 15/905,629

(22) Filed: Feb. 26, 2018

Related U.S. Application Data
(60) Provisional application No. 62/463,280, filed on Feb. 24, 2017.

(51) Int. Cl. C09K 8/524; C09K 8/536

(52) U.S. Cl. CPC C09K 8/524; C09K 8/536

(57) ABSTRACT

Hybrid sol-gel and SAM coatings, methods of applying hybrid sol-gel and SAM coatings to a substrate, surfaces comprising hybrid sol-gel and SAM coatings, and apparatus, machines, equipment and products having at least one surface comprising hybrid sol-gel and SAM coatings.

### CROSS-REFERENCE TO RELATED APPLICATION DATA

This application claims priority of U.S. Provisional Patent Application Ser. No. 62/463,280, filed Feb. 24, 2017.

### BACKGROUND OF THE INVENTION

### 1. Field of the Invention

The present invention relates to methods, apparatus and products relating to self-assembled monolayers (“SAM”). In another aspect, the present invention relates to methods, apparatus and products relating to hybrid sol-gel and self-assembled monolayers (“SAM”). In even another aspect, the present invention relates to methods, apparatus and products relating to hybrid sol-gel and self-assembled monolayers (“SAM”), in which the sol-gel is affixed to the surface of the substrate, and the SAM is affixed to the sol-gel. In still another aspect, the present invention relates to methods, apparatus and products relating to hybrid sol-gel and self-assembled monolayers (“SAM”) that have increased abrasion resistance as compared to SAM layers alone. In yet another aspect, the present invention relates to weak oxide substrates bearing hybrid sol-gel and self-assembled monolayers (“SAM”), to apparatus and products made thereof, and to methods of making and using same. In even still another aspect, the present invention relates to carbon steel substrates bearing hybrid sol-gel and self-assembled monolayers (“SAM”), to apparatus and products made thereof, and to methods of making and using same.

### 2. Description of the Related Art

Self-assembled monolayers (SAM) of organic molecules are molecular assemblies formed spontaneously on surfaces by adsorption and are organized into more or less large ordered domains. In some cases molecules that form the monolayer do not interact strongly with the substrate, and thus, the SAM may not be adequately anchored to the substrate.

It should be understood that SAMs are generally created by the chemisorption of “head groups” onto a substrate from either the vapor or liquid phase followed by a slow organization of “tail groups”. Initially, at small molecular density on the surface, adsorbate molecules form either a disordered mass of molecules or form an ordered two-dimensional “lying down phase”, and at higher molecular coverage, over a period of minutes to hours, begin to form three-dimensional crystalline or semicrystalline structures on the substrate surface. The “head groups” assemble together on the substrate, while the tail groups assemble far from the substrate. Areas of close-packed molecules nucleate and grow until the surface of the substrate is covered in a single monolayer.

However, problems may arise in those instances where the SAM is not adequately adhere itself to the underlying substrate.

Selecting the type of head group depends on the application of the SAM. Typically, head groups are connected to a molecular chain in which the terminal end can be functionalized (i.e. adding —OH, —NH2, —COOH, or —SH groups) to vary the wetting and interfacial properties. An appropriate substrate is chosen to react with the head group. Substrates can be planar surfaces, such as silicon and metals, or curved surfaces, such as nanoparticles. Alkanethiols are the most commonly used molecules for SAMs. Alkanethiols are molecules with an alkyl chain, (C—C)ⁿ chain, as the back bone, a tail group, and a S—H head group. Other types of interesting molecules include aromatic thiols, of interest in molecular electronics, in which the alkane chain is (partly) replaced by aromatic rings. An example is the dithiol 1,4-Benzenedimethanethiol (SHCH₂C₆H₄CH₂SH)). Interest in such dithiols stems from the possibility of linking the two sulfur ends to metallic contacts, which was first used in molecular conduction measurements. Thiols are frequently used on noble metal substrates because of the strong affinity of sulfur for these metals. The sulfur gold interaction is semi-covalent and has a strength of approximately 45 kcal/mol. In addition, gold is an inert and biocompatible material that is easy to acquire. It is also easy to pattern via lithography, a useful feature for applications in nanoelectromechanical systems (NEMS). Additionally, it can withstand harsh chemical cleaning treatments. Recently other chalcogenide SAMs: selenides and tellurides have attracted attention in a search for different bonding characteristics to substrates affecting the SAM characteristics and which could be of interest in some applications such as molecular electronics. Silanes are generally used on nonmetallic oxide surfaces; [symbol] however monolayers formed from covalent bonds between silicon and carbon or oxygen cannot be considered self-assembled because they do not form reversibly. Self-assembled monolayers of thiolates on noble metals are a special case because the metal-metal bonds become reversible after the formation of the thiolate-metal complex. This reversibility is what gives rise to vacancy islands and it is why SAMs of alkanethiolates can be thermally desorbed and undergo exchange with free thiols.

However, there are instances where these common head groups cannot adequately adhere themselves to the underlying substrate, perhaps because of incompatibility with the substrate. As an example, SAM's do not bond well to weak oxide substrates. There are other instances where the head group is adequately adhered, but cannot remain so because of underlying environmental conditions.

There are a number of published patent applications and patents directed to monolayers, the following of which are merely a few.

U.S. Pat. No. 6,146,767 issued Nov. 14, 2000, to Schwartz, discloses self-assembled organic ligand monolayers on the surface of a metal oxide or silicon oxide substrate overlayer, wherein transition metal atoms selected from Group IV, Group V or Group VI of the Periodic Chart are covalently bonded to the surface oxygens of the substrate, and each transition metal atom is further covalently bonded to one or more of the organic ligands of the monolayer, thereby covalently bonding the organic monolayer to the substrate overlayer. Methods of forming the self-assembled organic ligand monolayers of the present invention are also disclosed.

U.S. Pat. No. 7,268,363 issued Sep. 11, 2007, to Lenhard et al., discloses photosensitive organic semiconductor compositions comprising an organic p-type semiconductor pigment with a p-type conducting polymer, wherein the ionization potentials of the organic p-type semiconductor pigment and the p-type conducting polymer are nominally equivalent and a photosensitive organic semiconductor composition comprising an organic n-type semiconductor pigment with an n-type conducting polymer, wherein the electron affinities of the organic semiconductor pigment and the conducting polymer are nominally equivalent. Also disclosed are a p/n heterojunction utilizing the photosensitive organic semiconductor compositions.

U.S. Patent Application Publication No. 20080131709 published Jun. 5, 2008, to Hanson et al., discloses an article comprising: a substrate having a surface and comprising electrodeposited copper foil or copper alloy foil; an adherent layer serving to promote adhesion, comprising at least one organophosphonate or salt thereof covalently bound to the surface; and a functional layer, comprising at least one polymer bound to the adherent layer. The present invention further provides devices comprising a heat source or electronic component and the article described above, wherein the heat source is in thermal contact with the substrate and the electronic component is in electrical contact with the substrate. Also provided is a method of producing the above-described article.

U.S. Pat. No. 7,396,594 issued Jul. 8, 2008, to Schwartz et al., discloses carrier applied coating layers and a process for providing on the surface of a substrate an adherent phorphorous acid-based coating layer, the method comprising contacting said surface with a carrier conveying a coating composition comprising an acid selected from the group consisting of phosphoroic acids, organo-phosphoric acids, phosphonic acids, and mixtures thereof, at a sufficient temperature and for a sufficient time to bond at least a portion of the acid in the compositon to the oxide surface.

U.S. Pat. No. 7,471,503 issued Dec. 30, 2008, to Bruner et al., discloses solid electrolytic capacitors that comprise an organophosphorus material positioned between the dielectric layer and the polymeric electrolyte layer. The organophosphorus compound improves the interlayer adhesion between the dielectric and electrolyte layers.

U.S. Patent Application Publication No. 20090246394 published Oct. 1, 2009, to Hanson et al., discloses a method for applying a hydrophobic coating to a surface of a display screen is disclosed.

U.S. Pat. No. 7,625,149 issued Dec. 1, 2009, to Hanson et al., discloses a method and applicator for applying hydrophobic compositions to surfaces, wherein the applicator comprises an applicator tip fixed to a housing, and contained within the housing is a flowable hydrophobic composition of a metal silicon complex, and wherein the method includes applying the hydrophobic composition to a surface by rubbing the applicator tip across the surface.

U.S. Pat. No. 7,691,478 issued Apr. 6, 2010, to Avaltroni et al., discloses structures comprising substrates comprised of an organic material capable of accepting a proton from an organophosphorous compound and a film of the organophosphorous compound bonded to the substrate, which structures are useful in a variety of applications such as visual display devices.

U.S. Pat. No. 7,740,940 issued Jun. 22, 2010, to Hanson, discloses a coated article comprising a substrate having a plastic surface and adhered thereto an organometallic film in which the metal has f electron orbitals or is niobium, and also discloses methods for applying organometallic films to substrates and the organometallic films themselves.

U.S. Pat. No. 7,879,437 issued Feb. 1, 2011 to Hanson, discloses a non-particulate substrate having adhered thereto a coating composition comprising the reaction product of a transition metal compound such as niobium and a transition metal having electrons in the f orbital, and a silicon-containing material such as an organosilane or an organo(poly)siloxane, and discloses that reaction of the silicon-containing material with the transition metal compound results in a better adhering coating to the substrate than a comparable coating prepared from the silicon-containing material itself.

U.S. Pat. No. 7,879,456 issued Feb. 1, 2011, to Schwartz et al., discloses methods for bonding adherent phosphorous-containing coating layers to oxide surfaces on substrates wherein the substrates with oxide surfaces are selected from: (a) oxidized iron, titanium, silicon, tin and vanadium; (b) indium tin oxide; and (c) substrates with oxide layers deposited thereon, wherein the substrates on which oxide layers are deposited are selected from ceramics, semiconductors, metals, plastics and glass, and the method contacts the oxide surface with a carrier conveying an organo-phosphonic acid coating composition and heats the oxide surface and carrier at a sufficient temperature while maintaining contact for a sufficient time to bond a layer of the organophosphonic acid to the oxide surface. Coated articles prepared by the inventive method are also disclosed.

U.S. Pat. No. 7,901,777 issued Mar. 8, 2011, and U.S. Pat. No. 8,337,985 issued Dec. 25, 2012, both to Hanson, disclose a coated article comprising a substrate having a plastic surface and adhered thereto an organometallic film in which the metal has f electron orbitals or is niobium. Also disclosed are methods for applying organometallic films to substrates and the organometallic films themselves.

U.S. Pat. No. 7,989,069 issued Aug. 2, 2011, to Bruner et al., discloses an organometallic coating deposited from a metal alkoxide composition under conditions sufficient to form a polymeric metal oxide coating with unreacted alkoxide and hydroxyl groups. Also disclosed are substrates coated with the organometallic coating and a method for applying the organometallic coating to a substrate.

U.S. Pat. No. 8,025,974 issued Sep. 27, 2011, and U.S. Pat. No. 8,236,426 issued Aug. 7, 2012, both to Hanson et al., disclose inorganic substrates with a hydrophobic surface layer of a fluorinated material, wherein the fluorinated material can be directly adhered to the inorganic substrate or can be indirectly adhered to the inorganic substrate through an intermediate organometallic coating.

U.S. Patent Application Publication No. 20110252884 published Oct. 20, 2011 to Hanscombe et al., discloses a vibrating cylinder transducer for measuring the pressure or density of a fluid medium comprising: a cylindrical vibrator, in use having at least one surface coupled to a fluid medium to be measured; a drive means for vibrating the cylindrical vibrator; a sensor for detecting the resonant frequency of the cylindrical vibrator; and an output coupled to the sensor, the output configured to provide an output signal indicative of the pressure and/or the density of the fluid medium; wherein the surface coupled to the fluid medium is coated in a corrosion resistant polymer layer. Preferably the corrosion resistant polymer layer is formed from parylene, with self-assembled monolayer phosphonate coatings also mentioned.

U.S. Pat. No. 8,048,487 issued Nov. 1, 2011, and U.S. Pat. No. 8,524,367 issued Sep. 3, 2013, both to Hanson, disclose organometallic coatings or films, substrates coated with such films and methods for applying the films to the substrates. The organometallic film or coating is derived from a transition metal compound containing both halide ligands and alkoxide ligands. Coated articles comprising polymer substrates and adhered to the substrate surface an organometallic film in which the metal comprises halide and alkoxide ligands are also disclosed.

U.S. Pat. No. 8,053,081 issued Nov. 8, 2011, to Petcavich et al., discloses a cutting tool having a cutting edge with a layer of an organophosphorus compound.

U.S. Pat. No. 8,067,103 issued Nov. 29, 2011, to Hanson, discloses optical articles such as ophthalmic lenses containing a thin hydrophobic surface layer of a fluorinated material adsorbed thereon.

U.S. Patent Application Publication No. 20120003481 published Jan. 5, 2012, by Hanson, discloses organometallic coatings or films, substrates coated with such films and methods for applying the films to the substrates. The organometallic film or coating is derived from a transition metal compound containing both halide ligands and alkoxide ligands. Coated articles comprising polymer substrates and adhered to the substrate surface an organometallic film in which the metal comprises halide and alkoxide ligands are also disclosed.

U.S. Patent Application Publication No. 20120104362, published May. 3, 2012, by Hanson et al., discloses a method for altering an electronic property of a structure comprising an oxide surface or an oxide surface in electronic communication with the structure, the method comprising providing a covalently-bound film comprising at least one organic acid residue on a portion of the oxide surface so that at least one of the following properties of the structure is modified: (a) the charge carrier injection barrier properties; (b) the charge conductivity properties; (c) the charge transport properties; (d) the work function properties; (e) the sub-threshold slope; and (f) the threshold voltage.

U.S. Pat. No. 8,178,004 issued May. 15, 2012, to Hanson, discloses a composition and method for forming a hydrophobic coating on a metallic substrate. The composition comprises: (a) a perfluorinated acid, (b) a surfactant, (c) an organic solvent, and (d) water. The composition is applied to the metal surface, the organic solvent and water permitted to evaporate and coalesce to form a substantially continuous film that preferably is in the form of a self-assembled monolayer covalently bonded to the surface of the substrate.

U.S. Pat. No. 8,432,036 issued Apr. 30, 2013, to Hanson et al., discloses a lead frame and an electronic package having improved adhesion between the lead frame and an encapsulating plastic material. The lead frame can be pre plated having an outer layer comprising a precious metal such as palladium or gold to which is adhered a self-assembled monolayer (SAM), such as a SAM derived from an organophosphorus acid. The organophosphorus acid preferably is a mixture in which the organo groups are fluoro substituted hydrocarbons and hydrocarbons containing ethylenically unsaturated groups.

U.S. Pat. No. 8,445,423 issued May. 21, 2013, to Bruner et al., discloses wipes treated with organometallic compounds used in combination with organic acids in kit form, particularly organophosphorus acid. The kits can be used to treat various surfaces to alter the physical properties of the surfaces.

U.S. Pat. No. 8,558,117 issued Oct. 15, 2013, to Hanson, discloses an electroconductive ink made with metallic nanoparticles. The ink contains an organophosphorus acid that increases adhesion between the deposited metallic layer and the substrate to which the metallic layer is applied.

U.S. Pat. No. 8,658,258 issued Feb. 25, 2014, to Hanson, discloses an improved method for forming a self-assembled monolayer on a substrate, in which the method comprises plasma treatment of the substrate prior to formation of the self-assembled monolayer.

U.S. Patent Application Publication No. 2014/0134426, published May. 15, 2014, by Henry, discloses a synergistic multilayer anti-corrosion resistant coating for a metal surface, the coating having three subcoatings, a) a self-assembled monolayer nanoprimer; b) a polymeric primer; c) a polymeric top coat containing microcapsules for self-healing. The present invention is further direction to systems and methods for producing the coating in situ on the metal surface. The present invention provides an economical, non-epoxy-based, corrosion coating having favorable resistance to acid and to salt water, and having favorable adhesion properties.

U.S. Patent Application Publication No. 20140272149, published Sep. 18, 2014, by Hanson, discloses a process for forming a polymer film on a substrate through an intermediate organometallic layer. A self-assembled monolayer (SAM) containing an initiator for living polymerization such as controlled radical polymerization is formed on the organometallic layer followed by living polymerization such as controlled radical polymerization of a polymerizable monomer component.

U.S. Patent Application Publication No. 20140272150 published Sep. 18, 2014, by Hanson, discloses a process for forming a fluorocarbon polymer film on a substrate. A self-assembled monolayer (SAM) containing an initiator for living polymerization such as controlled radical polymerization is formed on the surface of the substrate followed by living polymerization such as controlled radical polymerization of a polymerizable fluorocarbon monomer component.

U.S. Patent Application Publication No. 20140272428 published Sep. 18, 2014, by Hanson, discloses a betaine-containing polymer film that can be formed on a substrate surface using living polymerization such as controlled radical polymerization.

U.S. Patent Application Publication No. 20150083397 published Mar. 26, 2015, by Monroe et al., discloses that fouling caused by contaminants onto a metallic tubular, flow conduit or vessel in an underground reservoir or extending from or to an underground reservoir may be inhibited by applying onto the surface of the metallic tubular, flow conduit or vessel a treatment agent comprising a hydrophobic tail and an anchor. The anchor attaches the treatment agent onto the surface of the metallic tubular, flow conduit or vessel.

U.S. Patent Application Publication No. 20150252656 published Sep. 10, 2015, by Hanson, discloses a method for recovering hydrocarbon material from a subterranean formation includes introducing a treatment fluid into the subterranean formation. One treatment fluid includes at least one organometallic material having a metal or metalloid from Group III of the Periodic Table or a transition metal. An optional second fluid having an organophosphorous material can also be introduced. Another treatment fluid includes the reaction product of a transition metal compound and a silicon-containing material.

In spite of the above advancements in the coating art, none of the above patents or publications address the issue where these common head groups cannot adequately adhere themselves to the underlying substrate.

### SUMMARY OF THE INVENTION

There is a need in the art to address the issue where SAM head groups cannot adequately adhere themselves to the underlying substrate.

There is another need in the art to address the issue where SAM head groups cannot remain adequately affixed because of underlying environmental or operating conditions.

There is even another need in the art for addressing application of SAM layers to weak oxide substrates, especially but not limited to carbon steel.

According to the present invention, there are provided hybrid sol-gel and SAM coatings.

According to another embodiment of the present invention, there are provided methods of applying hybrid sol-gel and SAM coatings to a substrate.

According to even another embodiment of the present invention, there are provided surfaces comprising hybrid sol-gel and SAM coatings.

According to still another embodiment of the present invention, there are provided apparatus, machines, equipment and products having at least one surface comprising hybrid sol-gel and SAM coatings.

While the present invention may be utilized on any type of substrate to which the sol-gel will adhere, it also finds utility when utilized on substrates having a weak oxide layer.

An oxide layer is a thin layer or coating of any oxide, such as iron oxide. It is a chemical compound containing oxygen and one other element. It can be protective, decorative or functional.

A stable oxide layer is one having denser and tightly bound oxides are impervious layers which checks further corrosion. E.G. element chromium (Cr) which forms a Chromia (Cr2O3) which is considered a stable impervious oxide layer is formed along the grain boundaries and surface. Compact oxide layers (closed structures) favor the protection of the metallic substrate.

In contrast, a less stable oxide layer (a “weak oxide” layer) is one that when the surface of normal steel (like Carbon Steel) is exposed to oxygen, it usually forms ferric oxide (Fe₂O₃) which has the well-known red rust color. Ferric oxide doesn't form a continuous layer on the steel because the oxide molecule has a larger volume than the underlying iron atoms, and eventually spalls off leaving fresh steel exposed which then starts a deleterious rusting cycle. Rust layers usually present considerable porosity, spallation and cracking. Cracked and non-protective oxide layers (open structure) allow the atmospheric oxygen to have access to the underlying surface of the metal. More porous oxide layers are less stable and have higher levels of material loss.

Generally speaking if the volume of metal oxide≥volume of metal, then the oxide layer is non-porous and stable. On the other hand, if the volume of metal oxide<volume of metal, then the oxide layer is porous and weak.

According to yet another embodiment of the present invention, there is provided a multilayer structure comprising a first layer comprising a sol-gel layer; and, a second layer comprising a self-assembled monolayer (SAM); wherein the first and second layers are affixed together.

According to even still another embodiment of the present invention, there is provided a structure comprising: a substrate; a first layer comprising a sol-gel layer affixed to the substrate; and, a second layer comprising a self-assembled monolayer (SAM), wherein the first and second layers are affixed together such that the first layer is sandwiched between the substrate and second layer.

According to even yet another embodiment of the present invention, there is provided a method of forming a multi-layer structure, the method including one or more of the following steps of: forming a sol-gel layer on a substrate; and forming a sefl-assembled monolayer (SAM) on the substrate, wherein the sol-gel layer is sandwiched between the substrate and the SAM.

According to still even another embodiment of the present invention, there is provided a method for handling precipitating solids comprising at least one selected from the group consisting of paraffin, asphaltene, greasy materials, oily materials, and hydrocarbon-based materials, comprising at least one of the following steps of: precipitating the solid; and, contacting a surface with the solid, wherein the surface comprises a Self-Assembled Monolayer (SAM) that is supported by a sol-gel layer.

According to still yet another embodiment of the present invention, there is provided method for handling solids comprising at least one selected from the group consisting of paraffin, asphaltene, greasy materials, oily materials, and hydrocarbon-based materials, comprising at least one of the steps of: contacting a surface with the solid, wherein the surface comprises a Self-Assembled Monolayer (SAM) that is supported by a sol-gel layer.

According to yet even another embodiment of the present invention, there is provided a method for precipitating solids comprising at least one selected from the group consisting of paraffin, asphaltene, greasy materials, oily materials, and hydrocarbon-based materials, the method comprising at least the step of: precipitating the solids in the presence of a surface comprising a Self-Assembled Monolayer (SAM) that is supported by a sol-gel layer.

According to yet still another embodiment of the present invention, there is provided a method for handling a liquid containing contaminants, wherein the contaminants comprise at least one selected from the group consisting of paraffin, asphaltene, greasy materials, oily materials, and hydrocarbon-based materials, and wherein the contaminants may comprise a solid phase in the liquid, be solubilized in the liquid, or both, the method comprising at least the step of: inserting into the liquid, a surface comprising a Self-Assembled Monolayer (SAM) that is supported by a sol-gel layer.

According to even still yet another embodiment of the present invention, there is provided a method for treating surfaces of equipment comprising one or more of the following steps of: Applying a sol-gel to at least one surface of the equipment to form a sol-gel layer; and, Applying a self-assembled monolayer (SAM) to the sol-gel layer such that the sol-gel layer is sandwiched between the surface and the SAM; wherein the equipment is selected from the group consisting of sucker rods, turbine meters, Coriolis meters, magnetic flow meters, down hole pumps, check valves, valves, cables, drill bits, wire lines, kitchen equipment, food processing equipment, vehicles, and pigs.

According to even yet still another embodiment of the present invention, there is provided Equipment comprising: at least one surface comprising a Self-Assembled Monolayer (SAM) that is support by a sol-gel layer, wherein the equipment is selected from the group consisting of sucker rods, turbine meters, Coriolis meters, magnetic flow meters, down hole pumps, check valves, valves, cables, drill bits, wire lines, kitchen equipment, food processing equipment, vehicles, and pigs.

According to still even yet another embodiment of the present invention, there is provided a system comprising: a liquid environment that comprises at least one contaminant selected from the group consisting of paraffin, asphaltene, greasy materials, oily materials, and hydrocarbon-based materials; and, a surface residing within the environment comprising a Self-Assembled Monolayer supported by a sol-gel.

These and other embodiments of the present invention will become apparent to those of skill in the art upon review of this application including its drawings.

### BRIEF DESCRIPTION OF THE FIGURES

The following non-limiting figures are provided merely to illustrate some of the embodiments of the present invention, and these figures are not meant to limit the invention or the scope of the claims, but rather to illustrate only certain non-limiting embodiments of the present invention.

FIG. 1 illustrates a prior art example of a SAM affixed directly to a substrate.

FIG. 2 illustrates a non-limiting embodiment of the present invention showing a hybrid sol-gel SAM structure affixed to a substrate.

FIG. 3 shows Chart I presenting contact angle measurements taken on the sample of Example 1, using hexadecane and deionized water.

FIG. 4 shows Chart II presenting contact angle measurements taken on the sample of Example 1 after the sample has been subjected to abrasion, using hexadecane and deionized water.

FIG. 5 shows Chart III presenting contact angle measurements taken on the sample of Example 2, using hexadecane and deionized water.

### DETAILED DESCRIPTION OF A PREFERRED EMBODIMENT

In some cases Self-Assembled Monolayers (SAM) do not adequately affix themselves to the underlying substrate. The reasons of course are varied but come down to the SAM head group not being fully compatible with the underlying substrate to the extent the head group does not adequately affix itself to the substrate, or perhaps the underlying environmental conditions do not allow the head group to remain adequately affixed to the substrate. For example, SAMs generally do not show good bonding to weak oxide substrates, including carbon steel.

In other cases, while a SAM might adequately affix itself to the underlying substrate, it does not maintain its structural integrity because of the underlying ambient conditions.

In any event, the present invention utilizes a hybrid structure in which a sol-gel that is adequately affixed to the substrate serves as the anchor for the SAM. The present invention finds utility with weak oxide substrates as the SAM layer may be strongly attached to such weak oxide substrates by the sol-gel which serves to tether or anchor the SAM to the substrate. Additionally, for all types of substrates, the present invention provides an improved structural integrity in those environments that are harsh for a SAM alone.

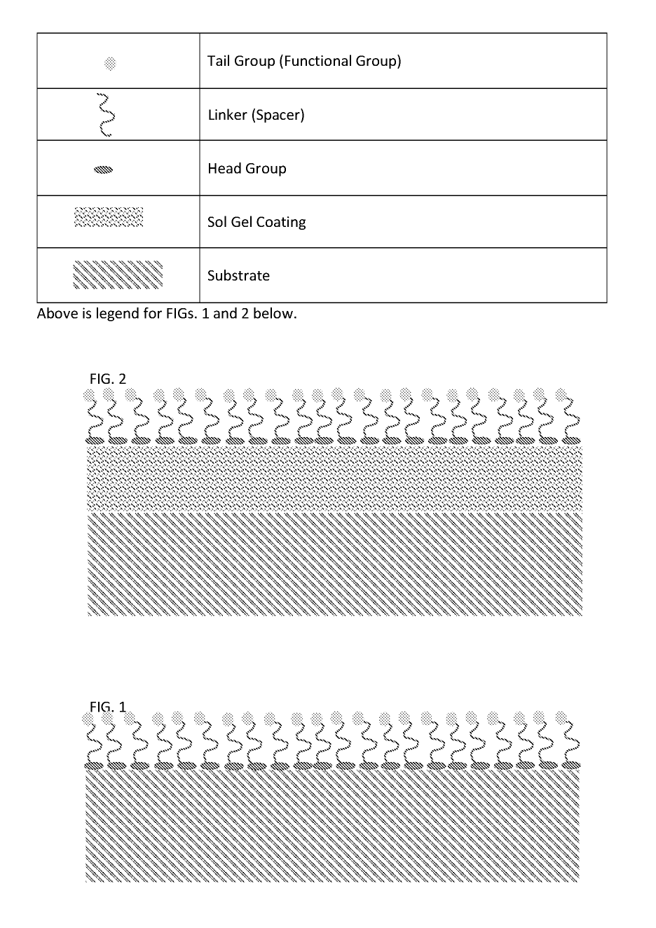

Referring now to FIG. 1 there is shown a prior art example of a SAM affixed directly to a substrate. In contrast, FIG. 2 shows the hybrid structure of the present invention, in which the sol-gel is affixed to the substrate, and the SAM is affixed to the sol-gel.

Thus the present invention provides methods, apparatus and products relating to hybrid sol-gel and self-assembled monolayers (“SAM”) structures.

The present invention also provides methods, apparatus and products relating to hybrid sol-gel and self-assembled monolayers (“SAM”), in which the sol-gel is affixed to the surface of the substrate, and the SAM is affixed to the sol-gel.

The present invention even also provides methods, apparatus and products relating to hybrid sol-gel and self-assembled monolayers (“SAM”) that have increased abrasion resistance as compared to SAM layers alone.

The present invention still also provides weak oxide substrates bearing hybrid sol-gel and self-assembled monolayers (“SAM”), and apparatus and products made thereof, and to methods of making and using same.

The present invention is also useful in those environments in which paraffin and/or asphaltene may be present, whether solubilized, in solid form, and/or in the process of precipitating.

The present invention may also find utility in kitchen environments in which oily/greasy substances are encountered.

The present invention may also find utility in transportation/vehicle environments in which various hydrocarbon based substances are encountered.

In addition to resistance against paraffins and asphaltenes and buildup of those substances, the present invention may also be useful in environments in which there are oily, greasy or grimy materials and provide resistance against buildup of those materials too.

The present invention also provides carbon steel substrates bearing hybrid sol-gel and self-assembled monolayers (“SAM”), provides apparatus and products made thereof, and provides methods of making and using same.

Certainly, sol-gels are well known and have a rich history in semiconductors, bio-implants, electrochromic displays and optical lenses. Sol-gels have been made of silicon dioxide, titanium dioxide, zirconium dioxide, aluminum oxide, barium titanium oxide, lead zirconate titanate and many others. Inorganic sol-gels are also well known and are typically made by metal alkoxide hydrolysis and condensation. Any suitable sol-gel may be utilized in the present invention. Further, methods of applying sol-gels to a surface are well known in the art, and any suitable application method may be utilized in the present invention.

One issue with sol-gels is that they can swell when immersed in fluids which will make them softer and more prone to damage. To provide protection from wax and asphaltene adhesion it will be important to protect the gel from damaged and to provide a surface that is incompatible with wax and asphaltenes. A common technique for strengthening the sol-gel treatment is to heat the surface to further condense the sol-gel to a less permeable more glass like structure. While effective to strengthen the layer the process can significantly degrade the anti-paraffin and anti asphaltene properties. Further, in the present invention, the sol-gel layer will be covered by the SAM layer.

In materials science, the sol-gel process is a method for producing solid materials from small molecules. The method is used for the fabrication of metal oxides, especially the oxides of silicon and titanium. The process involves conversion of monomers into a colloidal solution (sol) that acts as the precursor for an integrated network (or gel) of either discrete particles or network polymers. Typical precursors are metal alkoxides.

In this chemical procedure, the ‘sol’ (or solution) gradually evolves towards the formation of a gel-like diphasic system containing both a liquid phase and solid phase whose morphologies range from discrete particles to continuous polymer networks. In the case of the colloid, the volume fraction of particles (or particle density) may be so low that a significant amount of fluid may need to be removed initially for the gel-like properties to be recognized. This can be accomplished in any number of ways. The simplest method is to allow time for sedimentation to occur, and then pour off the remaining liquid. Centrifugation can also be used to accelerate the process of phase separation.

Removal of the remaining liquid (solvent) phase requires a drying process, which is typically accompanied by a significant amount of shrinkage and densification. The rate at which the solvent can be removed is ultimately determined by the distribution of porosity in the gel. The ultimate microstructure of the final component will clearly be strongly influenced by changes imposed upon the structural template during this phase of processing.

Afterwards, a thermal treatment, or firing process, is often necessary in order to favor further polycondensation and enhance mechanical properties and structural stability via final sintering, densification and grain growth. One of the distinct advantages of using this methodology as opposed to the more traditional processing techniques is that densification is often achieved at a much lower temperature.

The precursor sol can be either deposited on a substrate to form a film (e.g., by dip coating or spin coating), cast into a suitable container with the desired shape (e.g., to obtain monolithic ceramics, glasses, fibers, membranes, aerogels), or used to synthesize powders (e.g., microspheres, nanospheres). The sol-gel approach is a cheap and low-temperature technique that allows for the fine control of the product's chemical composition. Even small quantities of dopants, such as organic dyes and rare earth elements, can be introduced in the sol and end up uniformly dispersed in the final product. It can be used in ceramics processing and manufacturing as an investment casting material, or as a means of producing very thin films of metal oxides for various purposes. Sol-gel derived materials have diverse applications in optics, electronics, energy, space, (bio)sensors, medicine (e.g., controlled drug release), reactive material and separation (e.g., chromatography) technology.

Sol-gels suitable for use in the present invention may be created from a number of various oxides, non-limiting examples of which include metal alkoxides and organo metallic alkoxides. Non-limting examples of Metal Alkoxides (of the general form “M(OR)4”) include but are not limited to Tetramethyl orthosilicate (TMOS); Tetraethyl orthosilicate (TEOS); Tetrapropyl orthosilicate; Tetrabutyl Orthosilicate; Zirconium methoxide; Zirconium ethoxide; Zirconium propoxide; Zirconium butoxide; Aluminum methoxide; Aluminum ethoxide; Aluminum propoxide; Aluminum Butoxide; Titanium methoxide; Titanium ethoxide; Titanium propoxide; and, Titanium Butoxide. Non-limiting examples of organo metalic alkoxides include but are not limited to Methyltrialkoxysilane; Methyltriethoxysilane (MTEOS); Methyltributoxylsilane; Methyltripropoxylsilane; Propyltrimethoxy Silane (PTMS); 3-aminopropyltriethoxysilane (gamma-APS); and Cyanotruethoxysilane; Vinyltriethoxysilane.

Coupling agents suitable for use with sol-gels in the present invention include but are not limited to those of the form “Z—R—Si—(X)3”, including but not limited to Glycidyloxyalkyl Silanes; (3-glycidoxypropy;)triethoxyilane; 3-glycidoxytrimethoxylsilane (GLYMO); Glycidoxypropyltrimethoxysilane (GPTS); Acryloyloxyalkyl Silanes Alkyl Silanes; Methacryloxypropyltrimethoxysilane; Aminoalkyl Silanes; Methacrylic acid; and, Acrylic acid.

Functional groups suitable for use in the present invention with sol-gels include but are not limited to those of the form “R13 Si—(X)3”, in which R is functional group that is incompatible with wax and asphaltenes; X is a functional group that hydrolyzes and links with inorganics like the sol (chlorine, alkoxy, acetoxy, etc.);

Suitable examples of functional groups include but are not limited to 1-[3-(chlorodimethylsilyl)propyl]-2,3,4,5,6-pentafluorbenzene; Dimethylpentafluorophenylchlorosilane; Dimethylethoxysilylpentafluorbenzene; 1H,1H,2H,2H-tridacfluoro-n-octyltriethoxysilane; Trichloro(1H,1H,2H,2H-perfluoro-n-octyl)silane; Trichloro(1H,1H,2H,2H-perfluorodecyl)silane; 1,1,1-trifluoro-3-(trimethoxysilyl)propane; 1H,1H,2H,2H-nonafluorohexyltriethoxysilane; Triethoxy-1H,1H,2H,2H-perfluorodecylsilane; 1H,1H,2H,2H-heptadecafluorodecyltrimethoxysilane; 1H,1H,2H,2H nonafluorohexyltrimethoxysilane; Trichloro[3-(pentafluorophenyl)propyl]silane; and, Trimethoxy(pentafluorophenyl)silane.

Solvents suitable for use in the present invention for making sol-gels include but are not limited to alcohols, methanol, ethanol, propanol, butanol

Catalysts suitable for use in the present invention for making catalysts include Itaconic acid, HCl, Acetic Acid, NaOH, NH4, and NH4F.

Regarding the self-assembled monolayer (SAM) of the present invention, the selection of the SAM head group will generally depend upon the environment in which the coating will be utilized and the properties of the substrate on which it is applied. As non-limiting examples, the head groups may be mono, di or tri headed or as a bis, gem-bis or tris headed form, and may be selected from the group consisting of thiols, amines, silanes, siloxanes, selenides, tellurides, isocyanides, or heterocycles. Further, the head group will be selected for compatibility with the sol-gel utilized. Preferred SAMs are self-assembled monolayers of phosphonates. Certainly, any of the SAM's disclosed in any of the patents or publications listed herein (which are all herein incorporated by reference) are believed to be suitable for use in the present invention.

The building block of self-assembled monolayers (SAMs) is generally considered to be a molecule that bonds to a surface through a head group or linker that has an affinity for the surface or in this case, the sol-gel utilized. The molecule typically also has a spacer group and an end-group or tail. In additional to phosphonate, SAM's may also be formed from other moieties, including but not limited to thiols, amines, silanes, siloxanes, selenides, tellurides, isocyanides, or heterocycles.

Thiols form strong bonds and are stable over a wide range of temperatures, solvents, and potentials.

Carboxylic acids can also be used, and are also adept at displacing surface organics that could otherwise interfere with good surface treatment.

Amines are often used as terminal ends for SAMs to behave as a coupling agent to another layer. However, as a head group it could be useful to bond to sol-gels comprised of carbonates or sulfides.

Silanes and siloxanes can be used to bond to ceramics, glass, carbon fibers, masonry, and some polymeric materials. Trichlorosilane for example reacts with hydroxyl groups and forms a stable covalent bond.

Selenide provides similar chemistry as sulfide with an oxidation number of −2, and could be particularly useful for semiconductor applications particularly those made from gallium arsenide.

Tellurides are similar in chemistry to sulfides and selenides and also bond well to metals. Tellurides are found in natural gold deposits like calaverite, kernnerite, and sylvanite.

Isocyannide or carbylamine are also commonly utilized.

Heterocyles with one or two hetero atoms taken from the group of oxygen, nitrogen, sulfur, phosphorous, slicon, or arsenic most typically in 5 or six membered rings can form bonds with certain sol-gels. In many instances, the 3-membered rings are too reactive to remain heterocycle but could be used. Pyrrolidine, imidazonline, pyridines, thiazines, diazines are a few example of heterocycles that may be used as a head group.

In some cases it may be desirable to form SAM with more than one head group to obtain better surface coverage or durability through multiple bonds than with one head group alone. Any of the above described SAM's could be mono, di or tri headed or as a bis, gem-bis or tris headed compound. Multiple head groups could be connected through a single atom or each could have its own spacer.

Regarding the bis, tris and gem-bis compounds and nomenclature as utilized herein, for simple substituents (not themselves substituted) di- and tri- multiplying prefixes are used. The bis- and tris-multiplying prefix are used when the substituents are themselves substituted (or the ligand already has a di or tri in the compound name). Thus, as a non-limiting example, the term of “gem-‘bis-something’ group” is meant to refer to groups including two ‘something’ groups bound to a same carbon atom, and these groups therefore have a something-C-something bond. Same understanding is to be applied to “gem-tris-something group”. As a non-limiting example, “gem-bisphosphonate” is meant to refer to groups including two phosphonate groups bound to a same carbon atom. These groups therefore have a P—C—P bond.

Non-limiting examples of suitable bis compounds include: 1,2-bis(12-Dodecylphosphonic acid)disulfane; 2-bis(12-Diethyldodecylphosphonate)disulfane; adipolybisphosphonic acid; (6-Phosphonohexyl) phosphonic acid; 1,6-Hexanebisphosphonic acid; (5,5,6,6,7,7,8,8,9,9,10,10,11,11,11-pentadecafluoro-1-phosphonoundecan-3-yl) phosphonic acid. Other suitable examples of compounds useful in the present invention may be found in US20140000476 (bisphosphonic compounds), EP2054165A2 (gem bisphosphonic compounds), US20050153938 (polyphosphonate compounds), US20080220037 (biphosphonic compounds), US20130287955 (perfluorinated bisphosphonic compounds), and US20150103639 (phosphonic compounds), WO2015177229A3, and WO2015177229.

The hybrid sol-gel/SAM structures of the present invention find utility in a wide range of applications, may be utilized with any type of substrate to which sol-gel will attached, and may form part or all of the surfaces of any type of product or equipment. As a non-limiting example, the present invention find utility in hydrocarbon liquid, crude oil or other environments, especially environments in which paraffin and/or asphaltene may be present, whether solubilized, in solid form, and/or in the process of precipitating. As a non-limiting example, the present application finds utility in environments in which there is paraffin and asphaltene deposition, including but not limited to crude oil service operations. The present invention may be used to make coatings for reduction of paraffin and asphaltene deposition on various surfaces. The present invention finds utility as coatings for the reduction of paraffin and asphaltene deposition on certain surfaces of various equipment, including, but not limited to straight pipe, well pipe, sucker rods, turbine meters, Coriolis meters, magnetic flow meters, down hole pumps, check valves, valves, cables, drill bits, wire lines, safety valves, floating head storage tanks, and pigs, just to name a few.

As a non-limiting example, the present invention may find utility when utilized with sucker rods. In the production of oil and gas, a sucker rod is a rod, typically made of steel and between 25 and 30 feet (7 to 9 meters) in length, and threaded at both ends, used to join together the surface and downhole components of a reciprocating piston pump installed in an oil well. The pump jack is the visible above-ground drive for the well pump, and is connected to the downhole pump at the bottom of the well by a series of interconnected sucker rods that are extending through the cased or uncased wellbore. One problem encountered by sucker rods is the buildup of paraffin/asphaltenes on the surface of the sucker rod during operation in oil and gas wells. The buildup may occur to such an extent that the rod string can break under the added weight of the combined rod string and wax. In further method embodiments the present invention may be applied to one or more surfaces of the sucker rod to slow down, discourage or even prevent such buildup, resulting in further apparatus and products of the present invention.

The present invention will also have utility with a wide variety of flow meters in which it is important to slow down and/or prevent buildup of paraffin/wax on any surface of the meter to maintain the integrity of the meter. The present invention is believed to be useful on the surfaces of at least the following flow meters: mechanical flow meters such as piston meter/rotary piston (for example, oval gear meter), gear meter (for example helical gear nutating disk meter), variable area meter, turbine flow meter, Woltman meter, single jet meter, paddle wheel meter, multiple jet meter, Pelton wheel and current meter; pressure-based meters such as venturi meter, orifice plate, Dall tube, pitot-tube, multi-hole pressure probe, cone meters and linear resistance meters; optical flow meters; open-channel flow measurement meters such as level to flow, area/velocity, dye testing and acoustic doppler velocimetry; thermal mass flow meters such as the MAF sensor; Vortex flow meters; electromagnetic, ultrasonic and coriolis flow meters such as magnetic flow meters, non-contact electromagnetic flow meters, ultrasonic flow meters (Doppler, transit time), and coriolis flow meters; and laser Doppler flow measurement meters.

As another non-limiting example, the present invention may also have utility with turbine meters. In general, a turbine flow meter (better described as an axial turbine) translates the mechanical action of the turbine rotating in the liquid flow around an axis into a user-readable rate of flow (gpm, lpm, etc.). The turbine tends to have all the flow traveling around it. The turbine wheel is set in the path of a fluid stream. The flowing fluid impinges on the turbine blades, imparting a force to the blade surface and setting the rotor in motion. When a steady rotation speed has been reached, the speed is proportional to fluid velocity. Optionally, there may be positioned upstream and/or downstream of the turbine wheel one or more fluid stabilizers to help stabilize the fluid flow prior to contact with the turbine meter and/or as the fluid flows away from the turbine meter. Turbine meters are carefully machined to straighten the flow of fluids and pass them through a turbine to measure the flow through the meter. When operating in an oil and gas environment, especially where paraffin/asphaltene are an issue, the surfaces of the stabilizers, turbine wheel and/or even tube in which they are positioned may become coated with such paraffin/asphaltene buildup. When these surface become irregular due to such buildup they then cease to function properly and give erroneous results. In extreme cases deposition on the straitening vanes, turbine blades or housing may lead to plugging of the meter. Thus, in further method embodiments the present invention may be applied to one or more surfaces of the turbine meter, including to one or more surfaces of the stabilizers, turbine wheel and/or even tube in which they are positioned, to slow down, discourage or even prevent such buildup, resulting in further apparatus and products of the present invention.

Coriolis meters (also known as inertial or mass flow meters) are well known devices that measures mass flow rate of a fluid traveling through a tube. The mass flow rate is the mass of the fluid traveling past a fixed point per unit time. Coriolis meters generally comprise a set of parallel tubes in rotation or vibration, and an actuator which induces a vibration of the tubes. When the fluid to be measured is flowing, it is led through two parallel tubes that are designed to be counter-vibrating. The actual frequency of the vibration depends on the size of the mass flow meter, and commonly ranges from 80 to 1000 vibrations per second. When no fluid is flowing, the vibration of the two tubes is symmetrical. However, when there is mass flow, there is some twisting of the tubes. In those portions of the tube through which fluid flows away from the axis of rotation it must exert a force on the fluid to increase its angular momentum, so it is lagging behind the overall vibration. In other portions of the tube through which fluid is pushed back towards the axis of rotation it must exert a force on the fluid to decrease the fluid's angular momentum again, hence that arm leads the overall vibration. The inlet tube and the outlet tube vibrate with the same frequency as the overall vibration, but when there is mass flow the two vibrations are out of sync: the inlet arm is behind, the outlet arm is ahead. The two vibrations are shifted in phase with respect to each other, and the degree of phase-shift is a measure for the amount of mass that is flowing through the tubes. As might be guessed, flow of fluid through these tubes is quite sensitive to any paraffin/asphaltene buildup which might occur, especially when the fluid is a crude oil. Specifically, paraffin and asphaltene buildup on the surfaces of measurement tubes will cause a change in the cross sectional area of the tube at the point of buildup, and will cause a change in the mass of the tube at the point of buildup, either of which will have a detrimental effect on any resulting measurement. Thus, in further method embodiments the present invention may be applied to one or more surfaces of the Coriolis meter in contact with the flowing fluid (i.e., the interior surfaces of the tubes), to slow down, discourage or even prevent such buildup, resulting in further apparatus and products of the present invention.

Magnetic flow meters, often called “mag meter”s or “electromag”s, use a magnetic field applied to the metering tube, which results in a potential difference proportional to the flow velocity perpendicular to the flux lines. The potential difference is sensed by electrodes aligned perpendicular to the flow and the applied magnetic field. The physical principle at work is Faraday's law of electromagnetic induction. The magnetic flow meter requires a conducting fluid and a nonconducting pipe liner. The electrodes must not corrode in contact with the process fluid; some magnetic flowmeters have auxiliary transducers installed to clean the electrodes in place. The applied magnetic field is pulsed, which allows the flowmeter to cancel out the effect of stray voltage in the piping system. Because the magnetic flow meters measure the electromagnetic flux across the whole diameter of the measuring tube they can subject to asphaltene and asphaltene deposits that reduce the diameter and interfere with the proper operation of the meter. Thus, in further method embodiments the present invention may be applied to one or more surfaces of the magnetic flow meter in contact with the flowing fluid (i.e., the electrode and/or the interior of the flow tube), to slow down, discourage or even prevent such buildup, resulting in further apparatus and products of the present invention.

Downhole pumps, both reciprocating as well as rotational, both suffer from wax and asphaltene deposition. On reciprocating pumps the ball and seat assemblies can be fouled preventing a good seal and disrupting pump operation. Rotating pumps rely on spinning stages to increase pressure and small changes in the stage shape can cause flow to be disrupted and efficiency to drop to a point the pump must be pulled and replaced. Thus, in further method embodiments the present invention may be applied to one or more surfaces of downhole pumps in contact with the pumped fluid to slow down, discourage or even prevent such buildup, resulting in further apparatus and products of the present invention.

Check valves are used to control fluid by sealing at a specified pressure and only allowing flow when the pressure on the other side of the value exceeds the sealing pressure. The sealing pressure could come from well fluids, a spring, a control line, or other source of force. Check valves are often used as safety devices to allow flow to be relieved if a critical pressure is reached or to only allow flow if pressure is applied. In either case deposition on the internal components of the valve can either cause the valve to fail to open or fail to close which could shut in production or create a potentially hazardous situation due to over pressuring a line or vessel. Thus, in further method embodiments the present invention may be applied to one or more surfaces of check valves in contact with fluid to slow down, discourage or even prevent such buildup, resulting in further apparatus and products of the present invention.

Valves are used to control flow both for simple on and off control as well as to regulate flow rate. When the sealing surfaces are fouled with deposits they no longer can function as designed. When valves can no longer properly control flow a variety problems such as leaks, spills, fires, gas releases, or other hazards can occur. Thus, in further method embodiments the present invention may be applied to one or more surfaces of valves in contact with fluid to slow down, discourage or even prevent such buildup, resulting in further apparatus and products of the present invention.

Cables are used to supply power to downhole equipment. Deposits can form on the outside of the cables. Weight can become a problem with unsupported cables which could lead to breakage. For cables that are strapped to pipe the deposition interferes with the strapping used to keep the cable attached to the pipe. This slows the process of removing the equipment from the well. Thus, in further method embodiments the present invention may be applied to one or more surfaces of cables in contact with fluid to slow down, discourage or even prevent such buildup, resulting in further apparatus and products of the present invention.

Wirelines are used clean to wells, set tools, log wells, fish for broken tools or equipment and many other functions. Wirelines can pick up deposits that impede their ability to feed through guides, increase weight, foul centralizers, skates and other critical equipment needed for proper operation. Thus, in further method embodiments the present invention may be applied to one or more surfaces of wirelines in contact with fluid to slow down, discourage or even prevent such buildup, resulting in further apparatus and products of the present invention.

Non-limiting examples of commercial applicability of the present invention include petroleum production, petroleum pipelines, petroleum equipment (storage tanks and specialty vessels, etc.), and petroleum sensor and instrument manufacturing.

Outside of oil and gas applications, the present invention may find utility in kitchen, food processing, food manufacturing, food preparation, farm, ranch, and fishing environments in which greasy and oily substances may be found.

Certainly, all along the food processing chain from the raising, gathering, harvesting, processing, preparation and cooking of livestock, poultry, fish, game, grains, legumes, seeds, nuts and other foodstuffs, various greasy and oily substances are encountered. In those types of environments, grease may generally be described as a soap emulsified with some sort of oil or fat, such as mineral or vegetable oil or an animal fat/oil. Oily generally refers to fats, lipids, oils as are commonly encountered in such environments. In those types of environments, the present invention may find utility as surfaces on sinks, back splashes, vent hoods, utensils, fryers, pots, pans, tanks, lines/tubing/hose/pipes, liners, which surfaces provide resistance against buildup of those substances.

Further, there present invention may find utility as surfaces on various vehicles non-limiting examples of which include automobiles, trucks, motorcycles, scooters, mopeds, tractors, buses, vans, in which exposure to various hydrocarbon-based materials, including asphalts, road grime, engine grime, diesel, gasoline, oils, greases, hydrocarbons, hydrocarbon solvents is quite common. The present invention may find utility in providing surfaces that resist buildup of those hydrocarbon-based materials.

### EXAMPLES

The following non-limiting examples are being provided merely to illustrate certain, but not all embodiments and features of the present invention. These examples are not intended to, are not to be taken to, and certainly do not limit the scope of the claims of the present invention.

### Example No. 1

### Sample Preparation—Application of Coating

### Substrate: Carbon Steel. Dimension: 2.9″ L/1″ W/0.12″ T

The carbon steel utilized is a type of Iron steel with less than 2% of Carbon content and small composition of manganese, phosphorus, sulfur and silicon. This type of carbon steel is the most widely used Steel in Oil and Gas Industry, commonly used in flow lines, structural components, pipelines etc.

The following procedure was utilized to prepare both a Sol-Gel/SAM coated sample (using the full procedure), as well as a SAM only coated sample (using only the 2^{nd} half of the procedure).

A carbon steel substrate is first cleaned with a cleaner such that there is no debris, oil residue, dust or dirt. For the purpose of this example, a commercially heavy duty degreaser was used to clean the carbon steel substrate. Next, the carbon steel substrate was cleaned using a sponge, rinsed with tap water to remove all the soap residue. Next, the carbon steel substrate was wiped dry using a clean lint free cloth (Optionally an alcohol such as Isopropyl alcohol can be used as a final rinse and then dry the substrate with a clean lint free cloth).

Approximately 1 ml of the sol-gel solution is taken on a clean and dry lint free cloth. The sol-gel is then applied onto the clean carbon steel surface with the lint free cloth by using round circular polishing motion. This process is continued until all the surface, edges and corners of the carbon steel substrate are polished on with the sol-gel solution. The average coverage of the sol-gel used is 1-2 ml per square feet of surface area. Continue using the same lint free cloth and polishing on the substrate to ensure the sol-gel is applied all over and also to remove an excess solution that might have been left behind.

The sol-gel treated sample is allowed to rest such that the sol-gel can dry on all the surface, with drying time on the order of 5-15 minutes, after which time the sample should be dry to the touch. The dry carbon steel sample is now placed in a temperature controlled environmental chamber for a heat cure process. The temperature is 70 C and the heat cure time can range from 1 hour to 3 hours. For this purpose, the sample was heat cured at 70 C for 1 hour. After the heat cure step the sample is removed from the oven and allowed to cool down.

The sol-gel layer formed was estimated to be on the order of 150-200 nm thick after the cure step.

The sol-gel treated carbon steel sample is now ready to be treated with the second layer; which is a self-assembled monolayer. The self-assembled monolayer can be applied by different methods, namely wiping, dipping, spraying, flushing etc. The method used here is dipping.

A solution of a commercially available self-assembled monolayer (SAM) was utilized. The sol-gel treated carbon steel sample is placed in the solution, such that the whole sample is submerged. The samples are allowed sit in the SAM solution for minimum of 60 secs up to maximum of 5 minutes. Afterwards the sample was removed from the solution and allowed to dry. While a carbon steel sample so treated will be dry to touch within seconds, it is important to wait for 1-5 minutes before handling the sample. Next, a dry wipe or a clean lint free cloth is utilized to dry wipe the sample surface to remove any excess residue. The thickness of the SAM layer will range from 3-10 nm.

The carbon steel sample is now treated with a SAM by using a sol-gel as an intermediate adhesion and bonding layer.

### Sample Characterization

Method: Measuring Contact Angle of control fluids like Deionized (DI) water to measure the hydrophobicity of the surface, and n-hexadecane to measure the Oleophobicity of the surface.

A contact angle of 90 or greater with DI water is required to term the surface Hydrophobic.

A contact angle of 50 or greater with n-Hexadecane is required to term the surface Oleophobic.

Instrument: Kruss Drop Sharp Analyzer-DSA25.

Fluid Source: Deionized water (ASTM Type II) is sourced from LabChem. N-Hexadecane, 99% pure is sourced from Acros Organics.

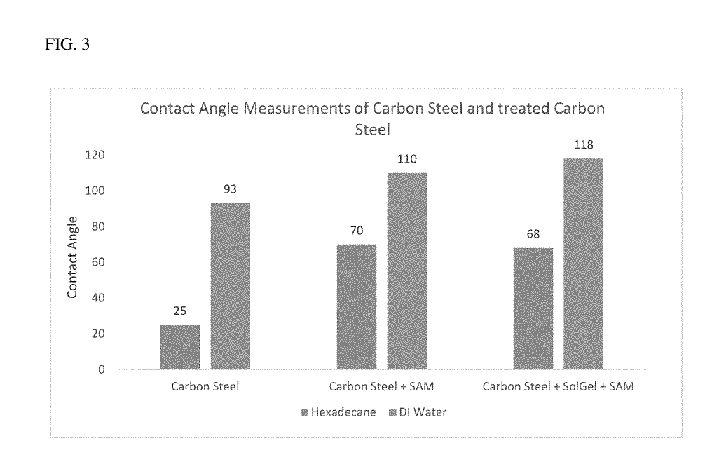

Chart I (FIG. 3) shows the contact angles of DI Water and n-Hexadecane obtained on
Carbon Steel as is without any treatment.
Carbon Steel treated with just a SAM
Carbon Steel treated with a SAM using the Sol Gel as the intermediate layer—thus forming a hybrid layer.

An abrasion test was carried out to compare the stability of the SAM layer on carbon steel and on carbon steel with sol gel as the intermediate layer. The Abrasion test conditions are noted below.

Instrument: Taber Industries 5750 Linear Abraser

Abrador: Kimwipes

Fluid/Medium: Isopropyl Alcohol

Weight: 220 grams

Force: 2 Newton

Cycles: 500

Speed: 60 cycles/minute.

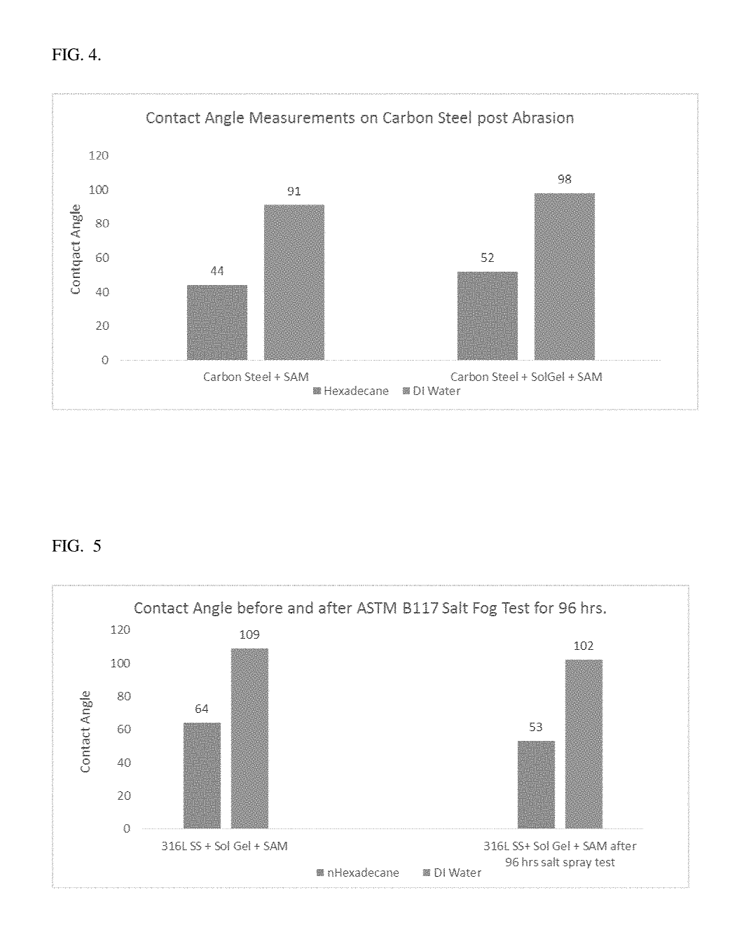

CHART II (FIG. 4) shows the contact angles of DI Water and n-Hexadecane obtained on
Carbon Steel treated with just a SAM and after the Abrasion test.
Carbon Steel treated with the hybrid layer and after the Abrasion test.

The contact angle data shows that there is a loss of oleophobic and hydrophobic properties of the carbon steel treated directly with SAM without the intermediate sol gel layer. On the contrary, the hybrid treatment on the carbon steel maintains its hydrophobic and oleophobic nature even after being exposed to the Abrasion test. This is indicative of the fact that the sol-gel layer is working as a durable intermediate layer between the carbon steel and SAM.

### Example No. 2

### Application Method

### Substrate: 316L Stainless Steel-Dimension: 2″ L/2″ W/0.01″ T

The 316 Stainless Steel is a standard molybdenum-bearing grade of austenitic stainless steels. 316L is the low carbon version of 316. It is used in heavy gauge welded components. It is rough, offers higher creep, stress to rupture and tensile strength.

The 316L stainless steel substrate is first cleaned with a cleaner such that there is no debris, oil residue, dust or dirt. For the purpose of this example, a commercially available heavy duty degreaser was used to clean the stainless steel (SS) substrate. The SS substrate was cleaned using a sponge, rinsed with tap water to remove all the soap residue. The SS substrate was wiped dry using a clean lint free cloth (optionally an alcohol such as Isopropyl alcohol can be used as a final rinse and then dry the substrate with a clean lint free cloth).

Approximately 1 ml of the sol-gel solution is taken on a clean and dry lint free cloth. The sol-gel is then applied onto the clean SS surface with the lint free cloth by using round circular polishing motion. This process is continued until all the surface, edges and corners of the SS substrate are polished on with the sol-gel solution. The average coverage of the sol-gel used is 1-2 ml per square feet of surface area. Continue using the same lint free cloth and polishing on the substrate to ensure the sol-gel is applied all over and also to remove an excess solution that might have been left behind.

The sol-gel treated sample is allowed to rest such that the sol-gel can dry on all the surfaces. The sample is allowed to dry for 5-15 minutes, and certainly will be dry to touch after 15 minutes. The dry SS sample is now placed in a temperature controlled environmental chamber for a heat cure process. The curing temperature is 70 C and the heat cure time can range from 1 hour to 3 hours. For this purpose, the sample was heat cured at 70 C for 1 hour. After the heat cure step the sample is removed from the oven and allowed to cool down.

The sol-gel will form a layer of 150-200 nm thick after the cure step.

The sol-gel treated SS sample is now ready to be treated with the second layer; which is a self-assembled monolayer. The self-assembled monolayer can be applied by different methods, namely wiping, dipping, spraying, flushing etc. The method used here is dipping.

A solution of self-assembled monolayer (SAM) is used here. The sol-gel treated SS sample is placed in the solution, such that the whole sample is submerged. The samples are allowed to sit in the SAM solution for minimum of 60 secs up to maximum of 5 minutes. Afterwards, the sample is removed from the solution and allowed to dry. While the SS sample will be dry to touch within seconds, wait for 1-5 minutes before handling the sample. Take a dry Kim wipe or a clean lint free cloth and dry wipe the sample surface to remove any excess residue. The thickness of the SAM layer will range from 3-10 nm.

The SS sample is now treated with a SAM by using a sol-gel as an intermediate adhesion and bonding layer.

Salt Fog Corrosion Test was carried out on 316L Stainless Steel treated with the hybrid layer. ASTM B117 standard and specifications were followed to carry out the test for 96 hours with exposure to 5% NaCl (Sodium Chloride) solution.

### Sample Characterization

Method: Measuring Contact Angle of control fluids like Deionized (DI) water to measure the hydrophobicity of the surface, and n-hexadecane to measure the Oleophobicity of the surface.

A contact angle of 90 or greater with DI water is required to term the surface Hydrophobic.

A contact angle of 50 or greater with n-Hexadecane is required to term the surface Oleophobic.

Instrument: Kruss Drop Sharp Analyzer-DSA25.

Fluid Source: Deionized water (ASTM Type II) is sourced from LabChem. N-Hexadecane, 99% pure is sourced from Acros Organics.

CHART III (FIG. 5) shows the contact angles of DI Water and n-Hexadecane obtained on
316L Stainless steel treated with the hybrid layer.
316L Stainless steel treated with the hybrid layer and after the Salt spray/fog test for 96 hours.

The contact angle data shows the hybrid treatment on the 316L stainless steel maintains its hydrophobic and oleophobic nature after being exposed to 96 hrs of ASTM B117 standard slat spray/fog testing. This is also an indication that the hybrid layer is durable and shows resistance to harsh environments.

All of the patents and publications cited herein are hereby incorporated by reference for all that they disclose, teach and suggest.

The foregoing is considered as illustrative only of the principles of the invention. Further, since numerous modifications and changes will readily occur to those skilled in the art, it is not desired to limit the invention to the exact construction and operation shown and described.

Those skilled in the art will recognize other embodiments of the invention which may be drawn from the illustrations and the teachings herein. To the extent that such alternative embodiments are so drawn, it is intended that they shall fall within the ambit of protection of the claims appended hereto.

Having disclosed the invention in the foregoing specification and accompanying drawings in such a clear and concise manner, those skilled in the art will readily understand and easily practice the invention.

What is claimed is:

1. A multilayer structure comprising:
a first layer comprising a sol-gel layer; and,
a second layer comprising a self-assembled monolayer (SAM); wherein the first and second layers are affixed together.

2. The structure of claim 1, wherein the SAM is a self-assembled monolayer of phosphonate.

3. The structure of claim 1, wherein the sol-gel is derived from a metal alkoxide or organo metallic oxide.

4. The structure of claim 3, wherein the metal alkoxide comprises at least one selected from the group consisting of tetramethyl orthosilicate (TMOS); tetraethyl orthosilicate (TEOS); tetrapropyl orthosilicate; tetrabutyl orthosilicate; zirconium methoxide; zirconium ethoxide; zirconium propoxide; zirconium butoxide; aluminum methoxide; aluminum ethoxide; aluminum propoxide; aluminum butoxide; titanium methoxide; titanium ethoxide; titanium propoxide; and, titanium butoxide, and wherein the organo metalic alkoxide comprises at least one selected from the group consisting of methyltrialkoxysilane; methyltriethoxysilane (MTEOS); methyltributoxylsilane; methyltripropoxylsilane; propyltrimethoxy silane (PTMS); 3-aminopropyltriethoxysilane (gamma-APS); cyanotruethoxysilane; and vinyltriethoxysilane.

5. A structure comprising:
a substrate;
a first layer comprising a sol-gel layer affixed to the substrate; and,
a second layer comprising a self-assembled monolayer (SAM), wherein the first and second layers are affixed together such that the first layer is sandwiched between the substrate and second layer.

6. The structure of claim 5, wherein the SAM is a self-assembled monolayer of phosphonate.

7. The structure of claim 5, wherein the sol-gel is derived from a metal alkoxide or organo metallic oxide.

8. The structure of claim 7, wherein the metal alkoxide comprises at least one selected from the group consisting of tetramethyl orthosilicate (TMOS); tetraethyl orthosilicate (TEOS); tetrapropyl orthosilicate; tetrabutyl orthosilicate; zirconium methoxide; zirconium ethoxide; zirconium propoxide; zirconium butoxide; aluminum methoxide; aluminum ethoxide; aluminum propoxide; aluminum butoxide; titanium methoxide; titanium ethoxide; titanium propoxide; and, titanium butoxide, and wherein the organo metalic alkoxide comprises at least one selected from the group consisting of methyltrialkoxysilane; methyltriethoxysilane (MTEOS); methyltributoxylsilane; methyltripropoxylsilane; propyltrimethoxy silane (PTMS); 3-aminopropyltriethoxysilane (gamma-APS); cyanotruethoxysilane; and vinyltriethoxysilane.

9. The structure of claim 5, wherein the substrate is carbon steel.

10. The structure of claim 5, wherein the substrate comprises a weak oxide layer and the sol-gel is affixed to the weak oxide layer.

11. A method for handling solids comprising at least one selected from the group consisting of paraffin, asphaltene, greasy materials, oily materials, and hydrocarbon-based materials, comprising the step of:
contacting a surface with the solid, wherein the surface comprises a Self-Assembled Monolayer (SAM) that is supported by a sol-gel layer.

12. The method of claim 11, wherein the SAM is a self-assembled monolayer of phosphonate.

13. The method of claim 11, wherein the sol-gel is derived from a metal alkoxide or organo metallic oxide.

14. The method of claim 13, wherein the metal alkoxide comprises at least one selected from the group consisting of tetramethyl orthosilicate (TMOS); tetraethyl orthosilicate (TEOS); tetrapropyl orthosilicate; tetrabutyl orthosilicate; zirconium methoxide; zirconium ethoxide; zirconium propoxide; zirconium butoxide; aluminum methoxide; aluminum ethoxide; aluminum propoxide; aluminum butoxide; titanium methoxide; titanium ethoxide; titanium propoxide; and, titanium butoxide, and wherein the organo metalic alkoxide comprises at least one selected from the group consisting of methyltrialkoxysilane; methyltriethoxysilane (MTEOS); methyltributoxylsilane; methyltripropoxylsilane; propyltrimethoxy silane (PTMS); 3-aminopropyltriethoxysilane (gamma-APS); cyanotruethoxysilane; and vinyltriethoxysilane.

15. The method of claim 11, wherein the sol-gel layer is supported by carbon steel.

16. The method of claim 11, wherein the sol-gel layer is supported by and affixed to a weak oxide layer.
